(19) United States
(12) Patent Application Publication
(10) Pub. No.: US 2008/0237437 A1
(43) Pub. Date: Oct. 2, 2008

(54) Support For Part To Be Coated By Electrolytic Deposition

(76) Inventors: David Henry, Meylan (FR); Frederic Porte, Grenoble (FR); Gerard Barrois, Le Fontanil (FR)

Correspondence Address: THELEN REID BROWN RAYSMAN & STEINER LLP, P. O. BOX 640640, SAN JOSE, CA, 95164-0640, US

(21) Appl. No.: 10/577,518

(22) PCT Filed: Oct. 26, 2004
(86) PCT No.: PCT/FR2004/050534

§ 371 Date: Jan. 22, 2008

(30) Foreign Application Priority Data
Oct. 31, 2003 (FR) 0350758

(51) Int. Cl. F16M 13/00

(52) U.S. Cl. 248/604

(57) ABSTRACT

The invention concerns mechanical retaining contacts (10) applied on a workpiece (4) placed on a substrate (1) by a double actuating mechanism (11, 42) which closes the circle of contacts (10) before lowering them onto the surface of the workpiece (4), thus ensuring a proper uniform contact. The contacts (10) may provide an electrical potential. The invention is applicable to electrolytic coating.

The subject of this invention is a support for a part to be coated by electrolytic deposition.

It may form an improvement to another invention by the same inventors (FR 2 842 536 A) published after the submission of this application. This prior invention relates to an electrolytic reaction vessel in which a part such as a wafer is placed on a substrate and is rotated towards a liquid flow that is as uniform as possible circulating in a loop inside the reaction vessel. The substrate is brought up to a cathodic electrical potential, and the liquid is enriched with ions that are deposited on the surface of the part. One aspect of this invention was attachment of the part onto the substrate: it was firstly housed in a hollow impression in the front face of the substrate, and curved hook shaped holding contacts extended around the substrate and retained the part in the cavity by pressing on it with their curved ends. Furthermore, the surface area and the depth of the cavity matched the surface area and the depth of the part, so that the part was actually flush with the surface of the substrate. The result was a uniform liquid flow in front of the part due to the continuity of the surface of part and the substrate, and the thinness of the holding contacts that created very-little disturbance.

The holding contacts were articulated to a support part that extended behind the substrate, to which it was connected by a position adjustment screw. Rotating the screw moved the support part away from the substrate and the holding contacts were free to turn to move towards each other in the radial direction and to move their ends in the longitudinal direction as far as the edge of the part; on the contrary, an opposite movement of the screw opened the circle of holding contacts while moving them away from the part.

The invention relates to a part support of this type that can be useful in electrolytic reaction vessels, that has the main advantage over the previous support in that it gives a much better assurance of a uniform attachment of the part through the holding contacts, which is particularly important when they are also used as electrical contacts to bring the part to the cathodic potential: if one of the contacts does not touch the part, a sufficient mechanical attachment could remain but there would often be a coating defect remaining at this location due to insufficient bias. It is often desirable that there should be a large number of holding contacts particularly around the periphery to assure a uniform electrical potential, particularly for relatively poorly conducting media. The known support does not provide a sufficient guarantee for this aspect, particularly due to the rudimentary nature of the mechanism on which the holding contacts are located, for which this position with respect to the support substrate of the part to be coated must be perfectly adjusted; and the tilting movement of the holding contacts is possible due to bending of thinned portions of the part that supports them, and which requires a faultless elasticity and precise manufacturing of these weakened portions.

The main innovation of the invention is that the closing movement of the circle of holding contacts in the radial direction is dissociated from the vertical movement of these holding contacts towards the part. A better guarantee about the equality of contacts for mechanical holding and a uniform cathodic potential can then be given, due to the use of more reliable mechanisms than an elastic articulation. Thus, the invention relates to a support for a part to be coated comprising a substrate with a front face in which there is a recess forming a part reception cavity, holding contacts for the part arranged around the substrate and curved towards the cavity, a first mechanism for deployment of the holding contacts in the radial direction, characterised in that it comprises a second mechanism for displacing the substrate perpendicular to the radial direction relative to the holding contacts; and the first mechanism comprises a holding contact carrier ring, slides fixing the ring to the substrate in rotation but leaving them free in translation, and a cam ring pressing on support portions of the holding contacts forming part of the carrier ring, the carrier ring and the cam ring being coaxial and designed so that they are mutually free in rotation.

One particularly advantageous mechanism is made if the holding contact supports are connected to a main annular portion of the carrier ring through articulations, and the cam ring comprises cam circles between which the carrier ring is retained, and the cams are arranged with an angular offset so as to press alternately on levers on the side opposite the articulations of the supports of the holding contacts.

Finally, the holding contacts may be provided with spring tips to better adjust the force by which they press on the part; hemispherical tips may be preferred.

The invention will now be described with reference to the figures, in which:

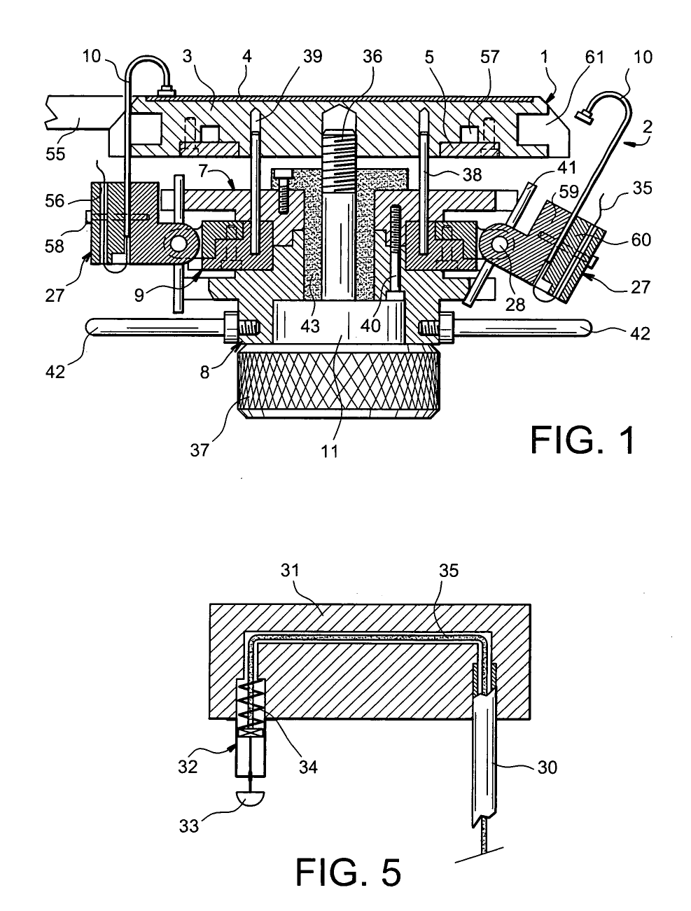

FIG. 1 shows a principal sectional view of the support;

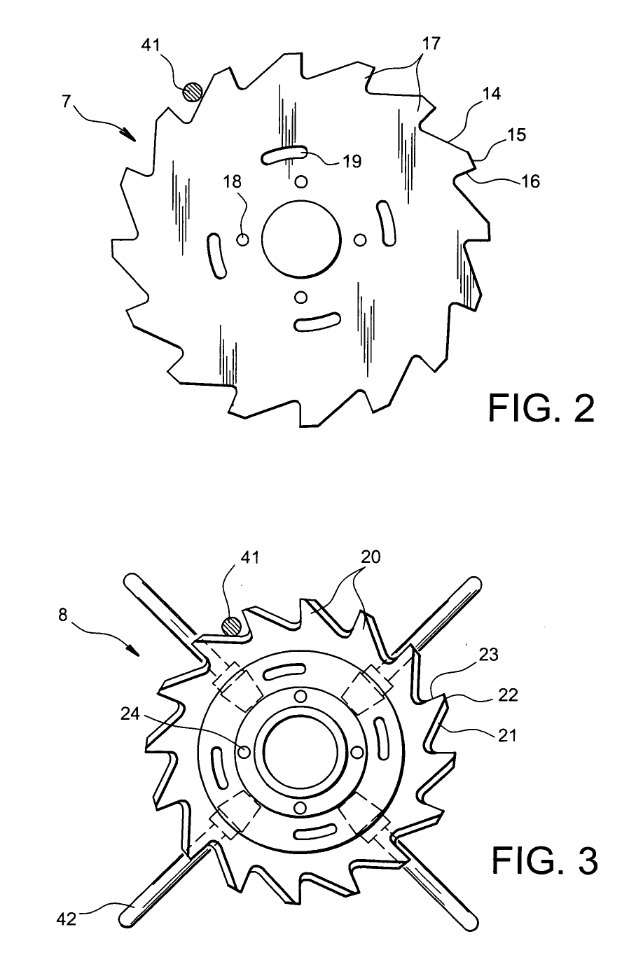

FIGS. 2 and 3 are top views of cam rings;

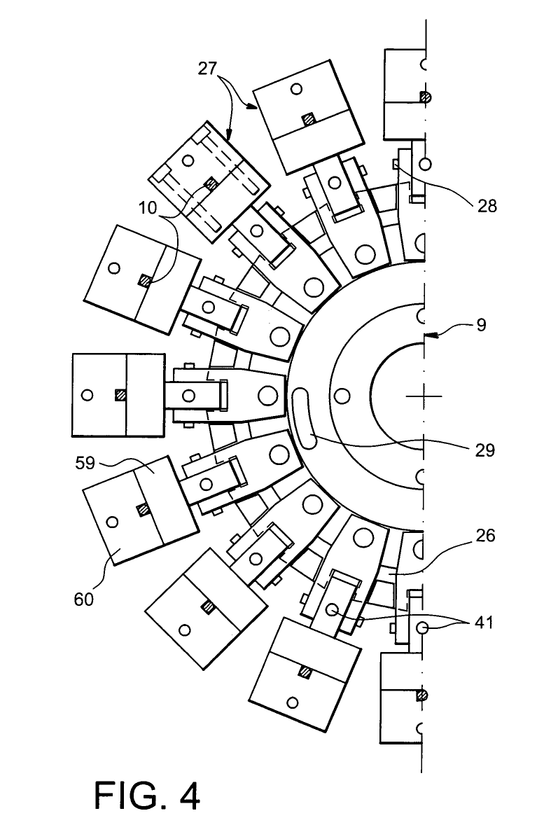

FIG. 4 is a top view of the holding contacts support ring;

and FIG. 5 is a view of a variant of holding and contact hooks.

Most of the parts that have just been described must be electrically insulating since they are immersed in a polarised electrolyte. They must also be chemically inert and resistant to the pH of the electrolyte.

As can be seen in FIG. 1, the support comprises essentially a substrate 1 and a set of mobile adjustment parts 2. The front face (the top face in FIG. 1) of the substrate 1 has a reception housing 3 for a part 4 to be coated in the form of a wafer that is only shown in outline. Its back face, facing the set of moving parts 2, may include a guide cover 5 for electrical bias wires. The substrate 1 forms a fixed part of the installation, that is supported by fixed armature of the reaction vessel through at least one radial arm 55 (shown partially on the Figure). The substrate 1 is completely immersed in the electrolyte, and a current runs from the electrolyte to the front face of the substrate and the wafer 4.

All mobile parts 2 comprise essentially a carrier ring 9, an upper cam ring 7, a lower cam ring 8, holding contacts 10 and an adjustment screw 11. These parts will be described in sequence.

The upper cam ring 7 is also shown in FIG. 2. It comprises a toothed periphery comprising oblique parts 14 corresponding to cam ramp parts, bearing parts 15 arranged in a circle and connection parts 16. A cam 17 corresponds to one of the teeth and is surrounded by these surfaces 14, 15 and 16. There is the same number of cams 17 as holding contacts 10, in this case sixteen. Finally, several circular drillings 18 and a few elongated slots 19 pass through the ring 7.

The lower cam ring 8, also shown in FIG. 3, has a similar shape with the same number of cams 20 as the cams 17 and along the edge of which there are oblique parts 21, bearing parts 22 and connection parts 23, but the inclinations of cams 17 are opposite to the inclinations of the cams 20. Since the connection parts 16 and 22 are above each other, the cams 17 overhang over the corresponding cams 20 and their inclined parts 14 and 21 intersect. The number, shape and arrangement of the drillings 24 are the same as the drillings in the upper cam ring 7, and these drillings also pass through this ring 8.

The ring 9 that carries the holding contacts 10, also shown in FIG. 4, comprises an annular shaped main part 26 and a series of support parts 27 and holding contacts 10 around its periphery; the support parts 27 are connected to the main part 26 through direction hinges 28. The main part 26 also includes drillings aligned with the slots 19.

The holding contacts 10 are hook shaped, engaged in the support parts 27 by a built-in end and are capable of pressing on the part 4 to be coated through their opposite free end that may be fitted with a suction cap to isolate the contact from the electrolyte. They may be electrically conducting (for example made from a CuBe alloy which has good elasticity) and surrounded by an insulating jacket, or they may be insulating but hollow and lined with electrical wires through which the cathodic potential is transferred to the part to be coated 4. However in the embodiment shown in FIG. 5, they are composite and include a hollow ceramic rod 30 built into the corresponding support 27, an arm 31 arranged in the radial direction and carrying a tip 32 with a hemispherical end 33 pushed by a spring 34 towards the part to be coated 4, at an end opposite to the rod 30.

The hemispherical shape assures that the surface area through which current is transferred remains unchanged even if the holding contact 10 is inclined, with no risk of damage to the part to be coated 4. A corrosion resistant coating such as gold plating covers this contact end.

The arm 31 is also hollow, and the electrical wire 35 can extend in the rod 30 and in the arm, as far as the tip 32. Embedment of the holding contacts 10 does not prevent them from being removed at will if it is necessary to reduce the number of contacts depending on the conductivity of the part 4 to be coated. A minimum number of contacts is desirable to reduce turbulence in the liquid.

The adjustment screw 11 passes through the central recesses of the rings 7, 8 and 9 and its threaded end 36 is engaged in a threading in the substrate 1. Its head 37 is knurled for easy gripping, and all moving parts 2 are supported on the head.

These various parts are connected together as described below. Slides 38 extend through the slots 19 and the drillings 29 of the rings 7 and 9 and also extend into the drillings 39 aligned with the substrate 1. Attachment screws 40 are engaged in the drillings 18 and 24 of the cam rings 7 and 8. Levers 41 are fitted on the support parts 27 close to the articulations 28 extending in the direction parallel to the holding contacts 10 and comprise opposite parts, each of which is at the height of one of the cam rings 7 and 8. The lower cam ring 8 is provided with an actuation rod 42. Finally, a bearing 43 is inserted between the adjustment screw 11 and the recesses of cam rings 7 and 8.

The substrate 3 is fixed to the carrier ring 9 in rotation by the slides 38, but is free in translation in the longitudinal direction; the cam rings 7 and 8 are rigidly connected together by screws 40; they hold the carrier ring 9 between them in the longitudinal direction, while allowing it to rotate with respect to the cam rings; finally, since the slides 38 pass through the cam rings 7 and 8 through elongated slots 19 and 25, they can rotate along these slots, namely a complete cam length or one sixteenth of a turn.

Rotation of cam rings 7 and 8 due to the actuation rod 42 makes the cams 17 and 20 slide on the levers 41 and makes the contact supports 27 move from a straight position to a position tilted downwards opposite the substrate 1, and the holding contacts 10 from a straight and closed (clamped) position (contacts armed) to an inclined and open position (contacts released). In the first of these states, the holding contacts 10 closely encircle the substrate 1 and their free ends extend above the periphery of the part to be coated 4; in the other of these states, the substrate 1 is free. In the first state, the part to be coated 4 can touch the holding contacts 10 after rotation of the adjustment screw 11 by rotating the head 37, which moves the substrate 1 away from the mobile part assembly 2 by sliding on the slides 38. The sequence of actions on the rod 42 and the adjustment screw 11 confirms dissociation of the two movements. The two opposite actions release the part to be coated 4.

The electrical connection wires pass beyond the holding contacts 10 under the support parts 27 through the drillings 56 at the back of the parts, upwards, and then through the substrate 1 to reach a circular housing 57 behind the cover 5. Finally, they extend into the holding arm 55 of the substrate 1 after passing through the substrate once again, as far as a cathode voltage source. Since they are independent, it becomes possible to distribute the electrical voltage into only some of the holding contacts 10 or to bring them to different potentials so as to produce irregular deposits on the part 4 to be coated.

The holding contacts 10 are disassembled by the division of support parts 27 on each side of them; connecting screws 58 join the halves 59 and 60 together so that they can be disassembled.

Finally, the substrate 1 comprises recesses 61 around its periphery at each holding contact 10 to hold an ammeter clip that measures the current passing in each contact 10 so as to check the uniformity of the value of the current.

1. Support for a part (4) to be coated, comprising a substrate (1) with a front face in which there is a recess forming a part reception cavity, holding contacts (10) for the part arranged around the substrate and curved towards the cavity, a first mechanism for deployment of the holding contacts in the radial direction, characterised in that it comprises a second mechanism (11, 38) for displacing the substrate perpendicular to the radial direction relative to the holding contacts; and the first mechanism comprises a ring (9) carrying the holding contacts (10), slides (38) fixing the ring (9) to the substrate (1) in rotation but leaving them free in translation, and a cam ring (7, 8) pressing on support parts (27) of the holding contacts forming part of the carrier ring (9), the carrier ring and the cam ring being coaxial and designed so that they are mutually free in rotation.

2. Support for a part (4) to be coated according to claim 1, characterised in that the holding contact supports are connected to a main annular portion (26) of the carrier ring (9) through articulations (28), and the cam ring is double and comprises two cam circles (17, 20) between which the carrier ring is retained, and the circle cams are arranged with an angular offset so as to press alternately on levers (41) on the side opposite the articulations of the supports of the holding contacts.

3. Support for a part to be coated according to claim 1, characterised in that it comprises a screw (11) with a stem inserted in the substrate and with a head (37) supporting the cam ring and the carrier ring (7, 8, 9).

4. Support for a part to be coated according to claim 1, characterised in that the holding contacts are fitted with spring tips (34).

5. Support for a part to be coated according to claim 1, characterised in that the holding contacts are fitted with hemispherical tips (33).

6. Support for a part to be coated according to claim 1, characterised in that the holding contact supports (27) can be divided in two halves (59, 60) between which the holding contacts (10) are retained.

7. Support for a part to be coated according to claim 1, characterised in that the holding contacts (10) are fitted with independent electrical power supply wires as far as an electrical power supply source located beyond an arm (55) supporting the support.
